(19) United States
(12) Patent Application Publication
(10) Pub. No.: US 2013/0180357 A1
(43) Pub. Date: Jul. 18, 2013

(54) BREATHER MEMBRANE PROTECTION DEVICE, GEAR MOTOR AND WIPER SYSTEM PROVIDED WITH SUCH A DEVICE

(71) Applicant: Valeo Systemes d'Essuyage, Le Mesnil Saint Denis (FR)

(72) Inventor: Jérôme Valliere, Les Ormes (FR)

(73) Assignee: Valeo Systemes d'Essuyage, Le Mesnil Saint Denis (FR)

(21) Appl. No.: 13/744,976

(22) Filed: Jan. 18, 2013

(30) Foreign Application Priority Data
Jan. 18, 2012 (FR) 1250484

(51) Int. Cl. F16H 57/027

(52) U.S. Cl. CPC F16H 57/027
USPC 74/608

(57) ABSTRACT

The invention concerns a device (1) for protecting a breather membrane (2) enabling the ventilation of a member, notably a gear motor of a wiper system, said device including a support (3) intended to accommodate said membrane (2) on the surface of said member and a cover (4) for protecting said membrane (2), said device (1) being configured to allow circulation of air between the interior and the exterior of the member via said membrane (2).

According to the invention, said cover (4), moulded in one piece with said support (3), is articulated relative to said support (3) so as to enable fixing of said membrane (2) onto said support (3) in an open position of said cover (4) and to cover said membrane (2) in a closed position of said cover (4).

The field of the present invention is that of the motor vehicle and, more particularly, that of equipments for wiping the windshield of motor vehicles.

Motor vehicles are routinely equipped with wiper systems comprising windshield wipers for washing the windshield and preventing distortion of the view that the driver has of their environment. These windshield wipers are conventionally driven by an arm effecting an angular to-and-fro movement and include elongate wipers, in turn carrying squeegee blades made from an elastic material. These blades rub against the windshield and evacuate the water out of the field of view of the driver.

The movement of the wipers is generated by an electric motor connected to a gear system. These parts are positioned in the vicinity of the wipers that they drive, i.e. in an area exposed to inclement weather.

To prevent condensation inside the gear system, it is known to provide the latter with a breather membrane, i.e. a watertight membrane that is permeable to air. Such a membrane must be protected from external aggression and it has already been proposed to place it under a cover that protects it whilst allowing air to circulate on either side of the membrane.

However, in the known solutions, the membrane is disposed on a support and the cover that protects the membrane is an independent part that must be mounted on and fixed to the support. This can cause problems.

An object of the present invention is to remedy these drawbacks by proposing a device for protecting a breather membrane enabling the ventilation of a member, notably a gear motor of a wiper system, said device including a support intended to accommodate said membrane on the surface of said member and a cover for protecting said membrane, said device being configured to allow circulation of air between the interior and the exterior of the member via said membrane.

According to the invention, said cover is moulded in one piece with said support. It is also articulated relative to said support so as to enable fixing of said membrane onto said support in an open position of said cover and to cover said membrane in a closed position of said cover.

Thus there is provided a cover connected to the support, at least during manufacture, whilst enabling fitting of the membrane to the member that must be equipped with it.

In various embodiments of the invention, together or separately:
said device includes an articulation hinge between said support and said cover,
said hinge is adapted to separate easily,
said support includes a surface for fixing said membrane and said hinge is situated in a plane different from that of said surface for fixing the membrane,
said cover is adapted to be clipped to said member,
said cover is fixed to said support.

The invention also concerns a gear motor provided with a breather membrane and a device for protecting said membrane as described above.

Said gear motor includes, for example, a housing accommodating a gear system, said protection device being produced in one piece with said housing.

The invention further concerns a wiper system provided with such a gear motor.

The invention will be better understood and other objects, details, features and advantages of the invention will become more clearly apparent in the light of the following detailed explanatory description with reference to the appended diagrammatic drawings of embodiments of the invention provided by way of purely illustrative and nonlimiting example.

In these drawings:

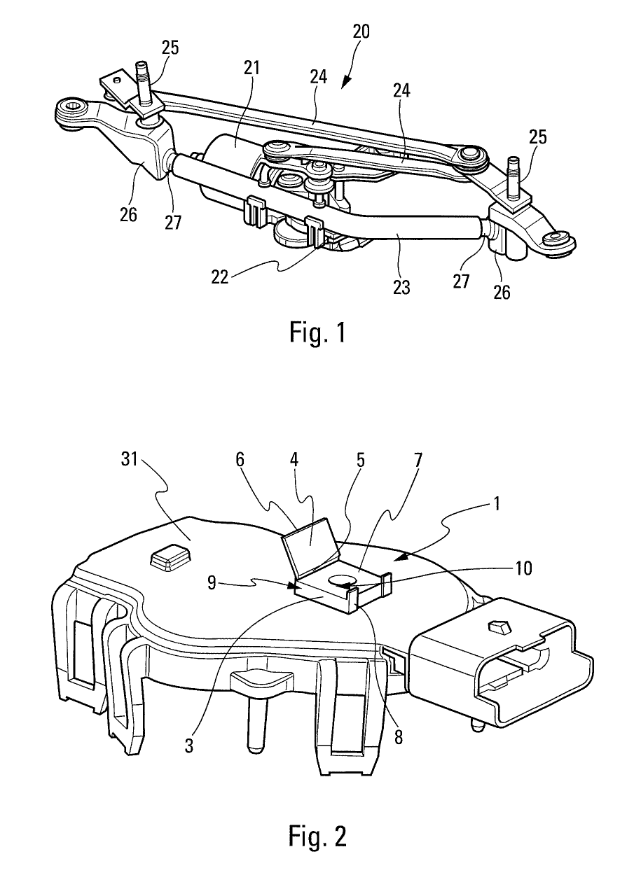

FIG. 1 is a general perspective view of a wiper system;

FIG. 2 is a perspective view of one embodiment of the protection device of the invention, said device being situated at the level of a gear system cover of the wiper system from FIG. 1, the breather membrane intended to be protected by said device not yet being fitted;

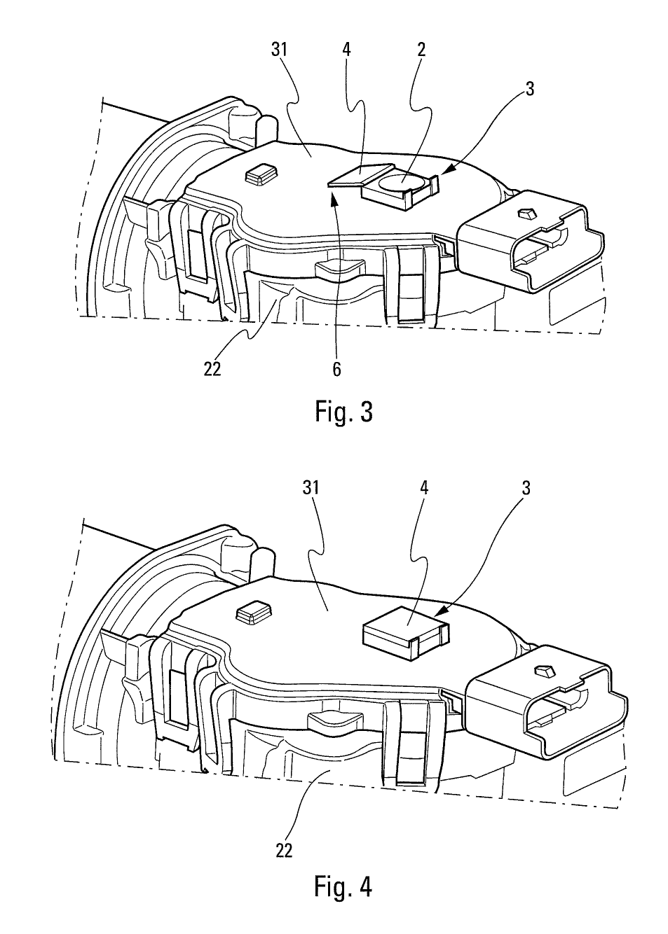

FIG. 3 is a perspective view of the device from FIG. 2 in a configuration in which it enables fitting of the membrane;

FIG. 4 is a perspective view of the device from FIG. 2 in a configuration in which it protects said membrane.

Referring to FIG. 1, there is seen an example of a vehicle wiper system to which the invention may be applied. It includes a drive gear motor 20. Here said gear motor 20 is carried by a tubular crossmember 23. It comprises a motor 21 connected to a gear system 22 that drives the arms of two windshield wipers, not shown, by means of links 24 that force those arms to pivot about two pivots 25. Each of these pivots is carried by a pivot support 26 that is fixed to the chassis of the vehicle. The two pivot supports are connected to each other by the tubular crossmember 23, which is hollow and which cooperates at each of its ends with a pin 27 extending from the corresponding pivot support.

As shown in FIGS. 2 to 4, the invention more particularly concerns a device 1 for protecting a breather membrane 2 enabling ventilation of a member, notably a cover 31 of the gear system of the wiper system.

Said membrane 2 allows air to pass from the interior of the member to its exterior, which makes it possible to limit the risks of condensation in the gear system 22, even in the motor 21. It is desirable to prevent any such phenomenon for the correct operation and the durability of the wiper system. The membrane 2 is moreover impermeable to the liquid to prevent any intrusion of water into the interior of the member. Such a membrane may for example be constituted of the material known as Goretex® or any other equivalent material.

Said protection device 1 includes a support 3 intended to accommodate said membrane 2 at the surface of said member and a cover 4 for protecting said membrane 2. Said cover 4 thus has a face, which cannot be seen, situated facing the membrane 2 and an opposite face 10. Said support 3 and/or said cover 4 are notably made of thermoplastic material.

Said device 1 is configured to allow circulation of air between the interior and the exterior of the member through said membrane 2 in order to be able to provide the required gaseous exchanges. Said support 3 and said cover 4 are thus disposed one relative to the other to enable such circulation.

According to the invention, said cover 4 is moulded in one piece with said support 3. It is moreover articulated relative to said support 3 so as to enable fixing of said membrane 2 on said support 3 in an open position of said cover 4 shown in FIGS. 2 and 3 and to cover said membrane 2 in a closed position of said cover 4 shown in FIG. 4.

In other words, the support 3 and the cover 4 are produced in the same material moulding step. Moreover, the cover 4 could be either open as in FIG. 2 or 3 or closed as in FIG. 4.

In the configuration of FIGS. 2 and 3, the membrane 2 can therefore be placed on the support 3. On this subject note that the membrane 2 is not yet in place in FIG. 2 whereas in FIG. 3 it has been placed on the support 3. To be more precise, in the FIG. 2 configuration, the cover 4 is partly open whereas in the FIG. 3 configuration it is in a fully open position, in contact with the member equipped with said membrane 2, here the cover 31 of the gear motor 20. In the FIG. 4 configuration, said membrane 2, not visible, is protected by said cover 4.

Thus there is provided a cover 4 for protecting the membrane 2 that has the advantage of being captive whilst providing no obstacle to the installation of the membrane 2 on the member that it must equip.

Said device could include an articulation hinge 5 between said support 3 and said cover 5. Said hinge 5 is notably constituted by a thinning of the material. In other words, the thickness of the material of the hinge 5 is less than the thickness of the material of the cover 4 so as to enable its articulation relative to the support 3.

According to a first aspect of the invention, shown in FIG. 3, said cover 4 is adapted to be clipped onto the member intended to be equipped with said membrane 2. To this end it has here a distal edge 6 adapted to be clipped onto said member. The cover 4 can thus be retained on said member either during fitting of the membrane 2 or in operation if the membrane 2 does not need to be protected. This provides a solution enabling the cover 4 to be used if required whilst preventing it from being lost since it remains attached to the device in all configurations.

According to another aspect of the invention, as an alternative to or addition to the preceding aspect, said hinge 5 is adapted to separate easily. Thus the decision can be taken either to tear off said cover 4 if it is not needed or to leave it fastened to said support 3.

Here said support includes a surface 7 for fixing said membrane 2 and said hinge 5 is situated in a plane different from that of said surface 7 for fixing the membrane 2. This ensures the presence of sufficient clearance between the membrane 2 and the cover 4 for the circulation of air through said membrane 2.

In the FIG. 4 configuration, said cover 4 is for example fixed, notably clipped to said support 3. To this end, said support 3 here includes fixing lugs 8 adapted to cooperate with the distal edge 6 of the cover 4.

Said support 3 includes, for example, a well 9 provided with said surface 7 for fixing said membrane 2. Said well 9 here has a substantially parallelepiped exterior shape and a circular through-orifice 10 intended to be capped by said membrane 2.

The cover 4 is plane, of substantially rectangular shape, and the same size as the surface 7 for supporting the membrane 2. The hinge 5 is situated along facing edges of said support 3 and the cover 4. The distal edge 6 of the cover 4 is situated on the opposite edge of the latter. The fixing lug 8 or each fixing lug 8 is situated on the opposite edge of the support 3.

Said protection device 1 is for example situated at the level of the gear motor 20, in particular at the level of a housing of the gear system 22 of said gear motor. Said housing accommodates a gear mechanism connected to a drive shaft of the motor 21 that cannot be seen. Said support 3 of said protection device 1 could be made in one piece with said housing. More particularly, said housing includes a body closed by the cover 31, said protection device 1 being made in one piece with said cover 31.

1. A device for protecting a breather membrane enabling the ventilation of a gear motor of a wiper system, said device comprising:
a support intended to accommodate said membrane on a surface of said member and a cover for protecting said membrane, said device being configured to allow circulation of air between an interior and an exterior of the member via said membrane, wherein said cover, moulded in one piece with said support, is articulated relative to said support so as to enable fixing of said membrane onto said support in an open position of said cover and to cover said membrane in a closed position of said cover.

2. The device according to claim 1, further comprising an articulation hinge between said support and said cover.

3. The device according to claim 2, wherein said hinge is adapted to separate easily.

4. The device according to claim 2, wherein said support includes a surface for fixing said membrane, and wherein said hinge is situated in a plane different from that of said surface for fixing the membrane.

5. The device according to claim 1, wherein said cover is adapted to be clipped to said member.

6. The device according to claim 1, wherein said cover is fixed to said support.

7. The device according to claim 7, wherein said cover is clipped onto said support.

8. A gear motor provided with a breather membrane and a device according to claim 1 for protecting said membrane.

9. The gear motor according to claim 8, comprising a housing accommodating a gear mechanism, said protection device being made in one piece with said housing.

10. A wiper system provided with a gear motor according to claim 8.
